(19) United States
(12) Patent Application Publication
(10) Pub. No.: US 2026/0178816 A1
(43) Pub. Date: Jun. 25, 2026

(54) AI-BASED WEBSITE RECONSTRUCTION SYSTEM AND METHOD

(71) Applicant: Wix.com Ltd., Tel Aviv (IL)

(72) Inventor: Ilan PALEIOV SADEH, Kfar Veradim (IL)

(21) Appl. No.: 19/428,194

(22) Filed: Dec. 21, 2025

Related U.S. Application Data
(60) Provisional application No. 63/738,570, filed on Dec. 24, 2024.

(51) Int. Cl. G06F 40/14; G06F 3/0482; G06F 3/0484; G06F 16/958; G06F 40/186; G06F 40/197

(52) U.S. Cl. CPC G06F 40/14; G06F 16/986; G06F 40/186; G06F 40/197; G06F 3/0482; G06F 3/0484

(57) ABSTRACT

A system for reconstructing a source website of a source modality into a new website of a target modality includes a Customer Management System (CuMS) and a deconstructor and constructor module. The Customer Management System stores a copy of the source website, which has a plurality of user interface (UI) entities. The deconstructor and constructor module, including an AI/ML Engine, iteratively deconstructs the website copy by identifying, recording a description for, and removing the last-added UI entity until the website is fully deconstructed, thereby creating an ordered list of UI entity descriptions. The module then processes this ordered list in a forward-chronological sequence. For the UI entity description, it generates and adds a corresponding new UI entity to the new website in the target modality.

### CROSS REFERENCE TO RELATED APPLICATIONS

The application claims priority from U.S. provisional patent application 63/738,570, filed Dec. 24, 2024, which is incorporated herein by reference.

### FIELD OF THE PRESENT DISCLOSURE

The present disclosure relates generally to website building systems and to systems for the artificial intelligence/machine learning (AI/ML) driven reconstruction of websites in particular.

### BACKGROUND OF THE PRESENT DISCLOSURE

Website design and development are dynamic fields that often require the reconstruction of an existing website. Reconstruction refers to the overall process of recreating a website, for example, when migrating a website from one technology platform to another or between different website hosts.

In one approach, website reconstruction is performed manually. In such an approach, a designer relies on visual analysis to replicate design elements, discerns the design flow, selects appropriate entities, and incrementally constructs the site piece by piece.

In other approaches, website reconstruction relies on identifying constituent technologies of a website, such as a specific software framework, database type, or web server, and applying a set of pre-defined rules or templates to redeploy the site. These approaches generally focus on environmental and backend configuration.

Further approaches operate as advanced web crawlers that download a website's content and reconstruct it based on its hyperlink structure. This approach replicates the final state of the site

Applicant has realized that the manual process is labor-intensive and prone to human error, resulting in inconsistencies and potential deviations from the original design. The manual approach requires a significant investment of time and effort as designers typically discern the design flow and incrementally construct the site, leading to extended project timelines and increased costs.

Applicant has further realized that existing automated systems and methods for website reconstruction typically rely on identifying the constituent technologies of a website, such as its framework or database type, and applying pre-defined rules or templates. Such methods focus on environmental and backend configuration but do not analyze the structural build process of the user interface itself. Other methods operate as advanced web crawlers that download a website's content and reconstruct it based on its hyperlink structure. This approach replicates the final state of the site but does not reverse-engineer the sequence in which it was constructed, failing to capture the logical order of UI/UX development. The discussion of any existing systems, methods, or techniques is provided solely to place the present disclosure in a technical context. Nothing in this Background section is admitted to be prior art against the claimed subject matter.

### SUMMARY OF THE PRESENT DISCLOSURE

The present disclosure provides a system and method that introduces a novel approach to website reconstruction, leveraging artificial intelligence (AI) to automate and streamline the process. The system reverse-engineers the original construction of a source website by conceptualizing it as a composition of user interface (UI) entities, which serve as the atomic units of reconstruction.

The disclosed system operates in two distinct phases: deconstruction and construction. In the deconstruction phase, an AI-driven process iteratively analyzes a copy of the source website to identify and record the properties of the most probable last-added User Interface (UI) entity. The entity is then removed, and the process is repeated until the website copy is fully deconstructed. Rather than exhaustively enumerating all possible build sequences or relying solely on manual redevelopment, this iterative “identify-and-remove” method allows the system to infer a likely construction sequence from the final website state and any available supporting information. The process results in the generation of a unique and specific technical data structure: an ordered list of UI entity descriptions of the source website. UI entities are conceptually identified in reverse-chronological order (from last-added to first-added), but their descriptions are stored in the list in chronological order (from first-added to last-added) so that the list can be processed straightforwardly during reconstruction. This chronologically ordered list constitutes a reverse-chronological blueprint of the website's original build sequence, derived from a reverse-chronological deconstruction but normalized into forward-chronological order to enable an efficient, sequential, and automated reconstruction process.

In the subsequent construction phase, the system utilizes the blueprint to systematically rebuild the website from scratch in a target modality. The blueprint data structure directly dictates the steps the constructor module takes. By processing the ordered list of UI entity descriptions in a forward-chronological order, the system assesses the function and intent of the source UI entities to select the most appropriate and functionally equivalent native component available in the target modality. The system generates and assembles the new UI entities one by one, acting as an intelligent translator between technologies. This methodical process ensures that the logical order of the UI/UX development is preserved, resulting in a reconstructed website that closely follows the original website's structure and interaction logic, even when migrating between incompatible technology platforms.

In some embodiments of the present disclosure, the system is further configured to solve the technical problem of migrating digital assets between incompatible environments. When a direct 1:1 entity match is not possible, the system technically partitions the reconstruction task. It automates what is computationally feasible and generates specific, structured data for parts requiring manual intervention. This may include inserting a placeholder entity into the code structure of the new website or exporting a task to an external management system. This optimizes a hybrid human-computer workflow by providing an interactive construction feedback module that allows a user to guide, approve, or modify the AI's suggestions, thereby providing finer control over the technical process of website generation and improving the efficiency of the human-computer interaction.

There is therefore provided, in accordance with an embodiment of the present disclosure, a system for reconstructing a source website of a source modality into a new website of a target modality, the source website including a plurality of user interface (UI) entities. The system includes a Customer Management System (CuMS) and a deconstructor and constructor module. The Customer Management System (CuMS) is configured to store a copy of the source website. The deconstructor and constructor module includes an AI/ML Engine and is configured to iteratively, until the copy of the source website is deconstructed, identify, using a deconstructor artificial intelligence/machine learning AI/ML engine, a last-added UI entity from the copy of the source website, record a description for the identified last-added UI entity, remove the identified last-added UI entity from the copy of the source website, thereby creating an ordered list of UI entity descriptions, and iteratively access the ordered list of UI entity descriptions, and process the ordered list of UI entity descriptions in a forward-chronological order to generate and add a corresponding new UI entity to the new website in the target modality for the UI entity description.

Moreover, in accordance with an embodiment of the present disclosure, the system further includes a site generation system configured to receive input from the deconstructor and constructor module and is configured to generate the final new website based on the reconstructed target website.

Further, in accordance with an embodiment of the present disclosure, the target modality is different from the source modality.

Still further, in accordance with an embodiment of the present disclosure, the deconstructor AI engine is trained on target modality websites.

Additionally, in accordance with an embodiment of the present disclosure, where the target modality is different from the source modality, the deconstructor AI engine is further trained on source modality websites.

Moreover, in accordance with an embodiment of the present disclosure, the deconstructor and constructor module includes a deconstructor module and a constructor module. The deconstruction module includes the AI/ML engine and is configured to iteratively, until the copy of the source website is deconstructed, identify, using the AI/ML engine, a last-added UI entity from the copy of the source website, record a description for the identified last-added UI entity, and remove the identified last-added UI entity from the copy of the source website, thereby creating an ordered list of UI entity descriptions. The constructor module is configured to interact with one of the AI/ML engine or the site generation system to iteratively access the ordered list of UI entity descriptions and process the ordered list of UI entity descriptions.

Further, in accordance with an embodiment of the present disclosure, the AI engine is further configured to identify the last-added UI entity by analyzing at least one of: a structure of the source website, dependencies between UI entities, or supporting information associated with the source website.

Still further, in accordance with an embodiment of the present disclosure, the supporting information is selected from the group consisting of: an editing history of the source website, user documentation, source code, and a website template used to create the source website.

Additionally, in accordance with an embodiment of the present disclosure, upon the deconstructor AI engine determining that the source website was created from the website template, the deconstructor module is configured to identify a base template and a list of customizations, where the ordered list of UI entity descriptions includes the list of customizations.

Moreover, in accordance with an embodiment of the present disclosure, the constructor module is further configured to, in response to determining that a UI entity from the source website cannot be directly replicated in the target modality, perform one of the following: generate a placeholder UI entity in the new website, the placeholder UI entity indicating a manual integration is required, or generate a task for an external task-management system, the task including an instruction for a manual process.

Further, in accordance with an embodiment of the present disclosure, the construction feedback module is further configured to present the user with a plurality of alternative new UI entities for a single UI entity description from the ordered list, and to receive a selection of one of the plurality of alternative new UI entities from the user.

Still further, in accordance with an embodiment of the present disclosure, the construction feedback module is further configured to receive from the user one or more parameters to be applied to a new UI entity before the new UI entity is added to the new website.

There is therefore provided, in accordance with an embodiment of the present disclosure, a computer-implemented method for reconstructing a source website of a source modality into a new website of a target modality, the source website including a plurality of user interface (UI) entities. The method includes storing, in a Customer Management System (CuMS), a copy of the source website. The method also includes, by a deconstructor module, iteratively identifying, using a deconstructor artificial intelligence/machine learning AI/ML engine, a last-added UI entity from the copy of the source website, recording a description for the identified last-added UI entity, removing the identified last-added UI entity from the copy of the source website, and repeating the identifying, recording, and removing steps until the copy of the source website is deconstructed, thereby creating an ordered list of UI entity descriptions. The method further includes, by a constructor module, accessing the ordered list of UI entity descriptions, and processing the ordered list of UI entity descriptions in a forward-chronological order to generate and add a corresponding new UI entity to the new website in the target modality for the UI entity description.

Moreover, in accordance with an embodiment of the present disclosure, the target modality is different from the source modality.

Further, in accordance with an embodiment of the present disclosure, the deconstructor AI engine is trained on target modality websites.

Still further, in accordance with an embodiment of the present disclosure, identifying the last-added UI entity further includes analyzing, by the AI engine, at least one of: a structure of the source website, dependencies between UI entities, or supporting information associated with the source website.

Additionally, in accordance with an embodiment of the present disclosure, the method further includes providing, by a construction feedback module, a user interface enabling a user to interact with the constructor module, where the user interaction includes at least one of: confirming a new UI entity, replacing the new UI entity, or modifying a property of the new UI entity.

Moreover, in accordance with an embodiment of the present disclosure, the method further includes determining, by the constructor module, that a UI entity from the source website cannot be directly replicated in the target modality, and in response, performing one of the following: generating a placeholder UI entity in the new website, or generating a task for an external task-management system.

### BRIEF DESCRIPTION OF THE DRAWINGS

The subject matter regarded as the present disclosure is particularly pointed out and distinctly claimed in the concluding portion of the specification. The present disclosure, however, both as to organization and method of operation, together with objects, features, and advantages thereof, may best be understood by reference to the following detailed description when read with the accompanying drawings in which:

FIG. 1A is a block diagram illustration of a website building system for reconstructing a website, constructed and operative in accordance with an embodiment of the present disclosure;

FIG. 1B is a block diagram illustration of the deconstructor and constructor module of the system of FIG. 1A, constructed and operative in accordance with an embodiment of the present disclosure;

FIG. 2A is a flow chart illustration of the iterative deconstruction process of the system of FIG. 1A, constructed and operative in accordance with an embodiment of the present disclosure;

FIG. 2B is a flow chart illustration of the process for identifying a last-added UI entity within the deconstruction process of FIG. 2A, constructed and operative in accordance with an embodiment of the present disclosure;

FIGS. 3A and 3B provide concrete examples of the intelligent, logic-based analysis performed by the AI/ML engine according to an embodiment of the present disclosure: FIG. 3A illustrate an example of the AI engine identifying the most probable last-added page of a website and FIG. 3B illustrate an example of the AI engine identifying the most probable last-added UI entity within a page;

FIG. 4A is a flow chart illustration of the construction process for creating a new website, constructed and operative in accordance with an embodiment of the present disclosure;

FIG. 4B is a block diagram illustration detailing the options for creating a new UI entity during the construction process of FIG. 4A, constructed and operative in accordance with an embodiment of the present disclosure;

FIG. 5 is a schematic illustration of the overall system architecture, showing the interaction between a source modality and a target modality, constructed and operative in accordance with an embodiment of the present disclosure; and

FIG. 6 is a flowchart illustrating a method according to an embodiment of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT DISCLOSURE

In the following detailed description, numerous specific details are set forth in order to provide a thorough understanding of the present disclosure. However, it will be understood by those skilled in the art that the present disclosure may be practiced without these specific details. In other instances, methods, procedures, and components that are considered conventional or widely implemented in computing systems have not been described in detail so as not to obscure the present disclosure.

The present disclosure introduces a novel methodology for website reconstruction, moving beyond simple replication of a final state to a reverse-engineering process (which can be compared to digital archaeology). The approach involves reverse-engineering the source website's UI structure and using it to build the target website. A deconstructor module, powered by an artificial intelligence (AI) engine, iteratively analyzes a copy of a source website. In a stepwise reverse-engineering process, it systematically identifies and removes the “last-added” user interface (UI) entity, layer by layer. For the removed entity, its essential properties—its characteristics, functionality, and position—are recorded. This continues until the website is reduced to its foundational state, yielding an ordered list of UI entity descriptions which serves as a detailed, sequential construction plan.

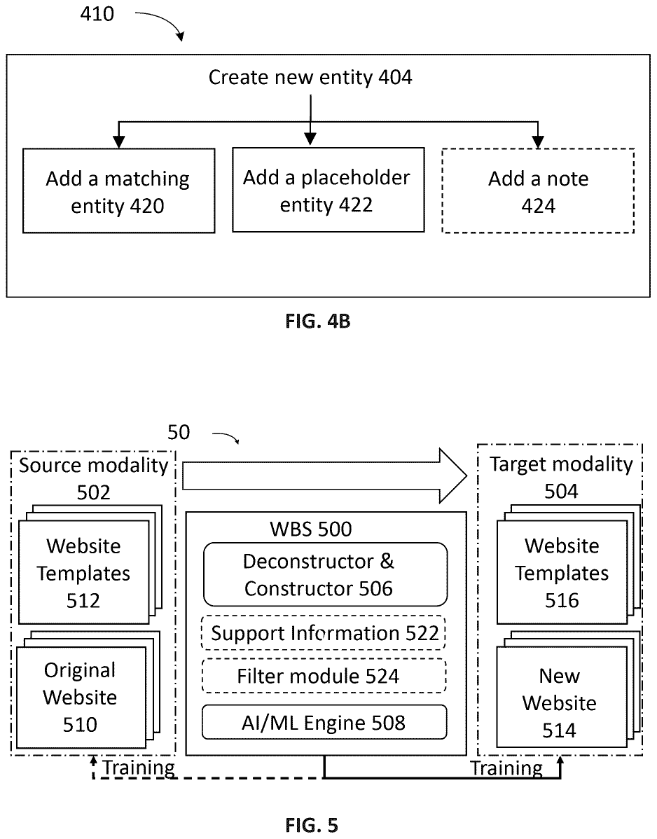

The reconstruction system comprises a reconstructor AI engine, which is trained to deduce the most probable chronological build order from a static, finished website. By understanding underlying patterns of websites, the system creates a construction plan that is not just a replica, but a logically sound and optimized sequence of steps. The reconstructor AI engine analyzes the visible structure and layout and can additionally leverage deeper contextual data, referred to as supporting information. “Supporting information” may include the original editing history, user documentation, or even the template upon which the site was built. In the detailed embodiments described below, the reconstructor AI engine functionality is provided by the AI/ML engine 104 (and the corresponding AI/ML engine 508 in the architecture of FIG. 5), which may be referred to as a “deconstructor AI engine” when operating in the deconstruction phase and as a “constructor AI engine” when assisting with construction.

The ordered list of UI entity descriptions becomes the instruction set for the constructor module. Starting with a blank website in a new target modality, the constructor processes the list in a forward-chronological sequence, rebuilding the website entity by entity. The deconstruction-construction flow ensures that the structural integrity and the original designer's interaction logic are preserved, resulting in a reconstructed website that preserves the original website's structure and interaction logic.

The system is further designed for real-world complexity, acknowledging that migrating between different technologies is rarely a direct one-to-one process. An interactive construction feedback module allows a human designer to guide, approve, or modify the AI's suggestions at desired steps. When direct replication is not feasible, the system provides concrete technical solutions, such as inserting a placeholder entity to mark where manual integration is needed or generating a note by exporting a task to an external management system. The hybrid human-computer workflow enables complex website migration scenarios to be handled by allocating tasks between automated reconstruction and human review, thereby optimizing the allocation of computational and human resources.

The value of the disclosed system and method becomes particularly clear when examined in the context of two migration scenarios.

Scenario 1—Intra-Ecosystem Migration (Same Website Builder, Different Technologies): In this scenario, a user wishes to migrate a source website from an older technology platform to a new, modern platform, where both platforms are offered by the same website builder. Here, the Customer Management System (CuMS) holds a comprehensive record of the source website, including not just its final state but potentially its entire editing history and the specific UI entities used in its creation. In this scenario, the AI engine may be trained on websites or both, the source modality and the target modality.

In Scenario 1, the system and method of the present disclosure provide a reconstruction process that uses the ordered UIED list instead of a simple 1:1 copy of the source website. The AI engine can analyze the rich supporting information, such as the editing history, to understand the original design process.

In some embodiments, the system and method of the present disclosure may attempt to identify and collapse redundant or “spurious” steps from a non-linear editing history to produce a cleaner and more logical, and efficient construction plan, while preserving the effective behavior of the resulting website. This optimization is best-effort: where the editing history is complex, inconsistent, or ambiguous, the system may retain additional intermediate steps or fall back to a more direct representation of the recorded history.

Scenario 2—Cross-Ecosystem Migration (Different Website Builders/Modalities): In scenario 2, the source website exists on a source modality (e.g., a custom PHP-based site) that is entirely different and may be incompatible with the target modality (e.g., a modern, component-based website builder). Here, the system operates using the publicly accessible version of the site without relying on backend access or an editing history.

In this scenario, the system maps website structures implemented, e.g., in one technology stack into functionally equivalent structures in the target modality. The deconstructor module analyzes the source website, creating the ordered list of UI entity descriptions. Critically, during the construction phase, the constructor module does not attempt a direct, and likely flawed, replication of the source code. Instead, the AI engine, having been trained on the target modality's templates, websites, and components, assesses the function and intent of the source UI entity. It then determines how that same entity would have been built natively in the target modality, selecting the most appropriate and functionally equivalent component available. When a direct equivalent does not exist, the system's value is further demonstrated through the construction feedback module, which facilitates a hybrid workflow by allowing for the insertion of a placeholder entity for manual coding or the creation of a note/task for a developer. The website reconstruction flow of the present disclosure preserves the essential UI/UX and interaction logic, solving the fundamental incompatibility problem that makes cross-platform migrations so challenging.

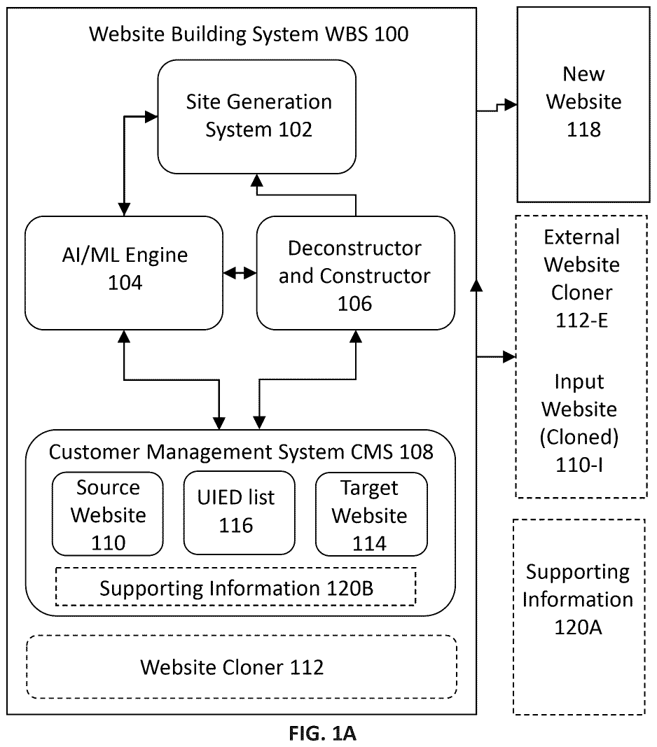

Reference is now made to FIG. 1A, which is a block diagram illustration of a website building system (WBS) 100 for reconstructing a website, constructed and operative in accordance with some embodiments of the present disclosure.

System 100 is configured to receive an input website 110-I, which is a version of a source website to be reconstructed, and may also receive external supporting information 120A.

In some embodiments, system 100 includes a website cloner 112 configured to create a copy of the input website 110-I. In other embodiments, system 100 receives a copy of input website 110-I from an external website cloner 112-E. Website cloner 112 or external website cloner 112-E may apply any suitable website cloning and copying technique. In modalities where the source website exhibits dynamic, personalized, or multi-state behavior, the copy may correspond to one or more captured rendered snapshots for a selected viewport, user context, or interaction state. The deconstruction process operates on the chosen representation or representations and infers a build sequence for those representations without requiring that every possible runtime state of the source website be enumerated. The system and method of the present disclosure are not limited by the type of website cloning that is used.

Representation of a website (or website state). As used herein, a “representation” of a website (or of a website state) includes one or more machine readable descriptions of the website's user interface (UI) entities and their relationships. Non limiting examples of such a representation include: (a) Document Object Model (DOM) information (e.g., a DOM tree, DOM snapshot, and/or DOM paths); (b) a hierarchical listing of UI entities (e.g., a component tree, UI tree, and/or view hierarchy representation); (c) one or more rendered snapshots for a selected viewport, user context, and/or interaction state; and/or (d) associated metadata and supporting information such as resource dependencies, layout metrics, editing history, version history, user documentation, and/or source code. A representation may be obtained from the CuMS stored copy, from a website cloner/crawler, and/or from runtime instrumentation.

System 100 comprises a Customer Management System (CuMS) 108, which functions as a central data repository. The CuMS 108 is configured to store the copy of the source website 110, internal supporting information 120B if available, a generated User Interface Entity Description (UIED) list 116, and a target website 114 being constructed.

A deconstructor and constructor module 106 operates in communication with a deconstructor artificial intelligence/machine learning AI/ML engine 104. During a deconstruction phase, the AI/ML engine 104 is configured to analyze the source website 110, potentially using supporting information 120A and 120B, if available, to iteratively identify the most probable last-added user interface (UI) entity. The deconstructor and constructor module 106 then generates a description of the entity, adds the description to the UIED list 116 within the CuMS 108, and removes the entity from the copy of the source website. Conceptually, this iterative process identifies UI entities in reverse-chronological order, from last-added to first-added. In some implementations, each new description is pre-pended to the list or the resulting list is reversed at the end of the deconstruction phase so that the persisted UIED list 116 is chronologically ordered from first-added to last-added. The process repeats until the source website is deconstructed, yielding the UIED list 116 as a reverse-chronological blueprint that is stored in a convenient forward-chronological order for use during the construction phase.

In other embodiments, the UIED list may be persisted in reverse chronological order (e.g., by appending each newly identified last added UI entity description), and the constructor module may reconstruct by traversing the persisted UIED list in reverse order or by reversing the persisted UIED list prior to traversal. The choice of storage order and traversal order is an implementation detail, and both approaches can result in generation of the same reconstructed website in the target modality.

In some embodiments of the present disclosure, with reference to FIG. 1A, the artificial intelligence/machine learning AI/ML functionalities may be distributed across multiple specialized components. For example, the AI/ML Engine (104) may be configured to perform analysis exclusively for the deconstruction phase, identifying the last-added UI entity and generating the UIED list (116). In such a configuration, the Site Generation System (102) may comprise its own dedicated constructor AI/ML engine (not shown), which is specifically trained on the target modality (504). This constructor AI/ML engine would be responsible for interpreting the UIED list (116) and intelligently selecting the appropriate native components to generate the final new website (118). This modular architecture allows the AI/ML engine to be independently optimized for its specific task-deconstruction or construction.

In other embodiments, the AI/ML engine (104) may be implemented as a remote, cloud-based service accessible via an application programming interface (API). In this configuration, the deconstructor and constructor module (106) would not communicate with an internal engine but would instead send analysis requests to, and receive results from, the external AI/ML service. For instance, during deconstruction, the module (106) could transmit a representation of the current website (202) to the remote service and receive back the identification of the last-added UI entity. Similarly, during construction, it could send a UI entity description from the UIED list (116) and receive back a suggested native component from the target modality. This configuration allows the AI/ML engine (104) to be centrally managed, updated, and scaled independently of the local website building system (100).

During a subsequent construction phase, the deconstructor and constructor module 106 processes the UIED list 116 in a forward-chronological order to build the new target website 114 within the CuMS 108. A site generation system 102, which receives input from the deconstructor and constructor module 106 and the AI/ML engine 104, is configured to generate the final new website 118 based on the reconstructed target website 114.

Reference is now made to FIG. 1B, which is a block diagram illustration with of the deconstructor and constructor module 106 of FIG. 1A, constructed and operative in accordance with some embodiments of the present disclosure.

The deconstructor and constructor module 106 is shown to comprise three primary functional sub-modules: a deconstructor module 106A, a construction feedback module 106B, and a constructor module 106C.

The deconstructor module 106A is configured to manage the deconstruction phase of the website reconstruction process. It operates iteratively to analyze a copy of a source website, and in conjunction with the AI/ML engine (104, FIG. 1A), identifies and records the properties of the most probable last-added UI entity. It then directs the removal of the entity and repeats the process, thereby generating the reverse-chronological blueprint of the website's original build sequence.

The constructor module 106C is configured to manage the construction phase. It processes the blueprint created by the deconstructor module 106A in a forward-chronological order. For the entity description in the blueprint, it generates and assembles a corresponding new UI entity in the target modality, progressively rebuilding the website.

The construction feedback module 106B, which may be an optional component in some embodiments as indicated by its dashed outline, provides a user interface for human interaction during the construction phase. The module enables a hybrid human-computer workflow, allowing a user to guide, approve, or modify the suggestions of the AI engine. For instance, when a direct replication of a UI entity is not feasible, the construction feedback module 106B may present the user with options, such as selecting from alternative components, inserting a placeholder for subsequent manual coding, or generating a task for an external management system.

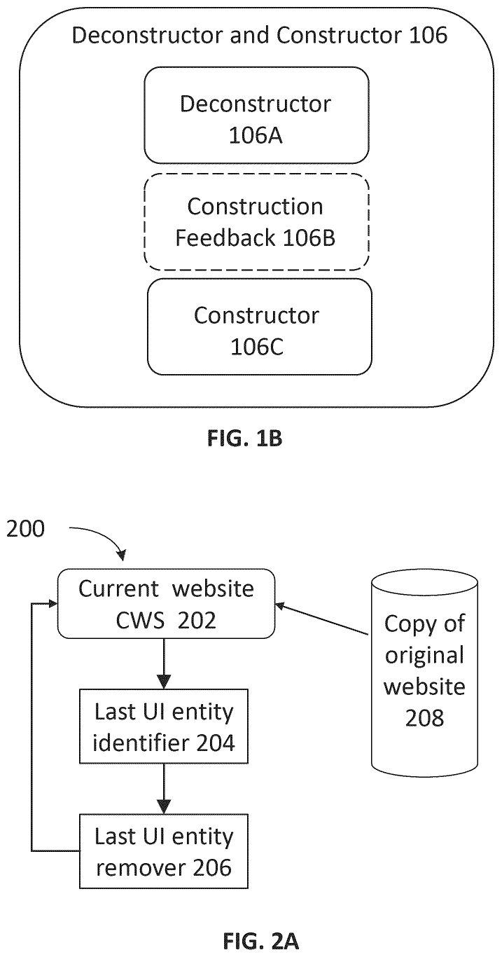

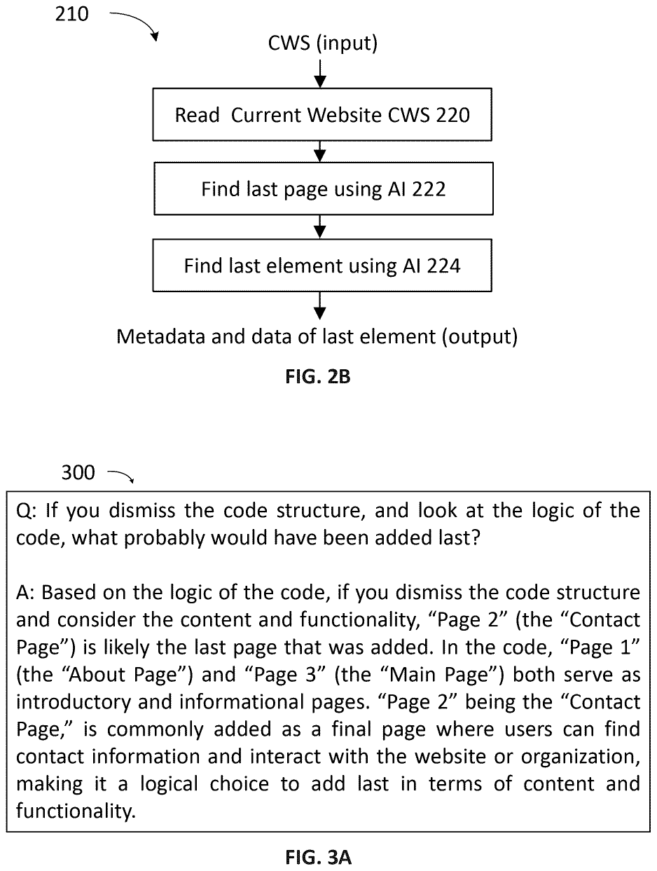

Reference is now made to FIGS. 2A, 2B, 3A, and 3B, which illustrate the operation of the deconstructor module 106A. The deconstructor module 106A is configured to perform a systematic, iterative reverse-engineering of a source website's construction sequence. The ultimate output of the process is an ordered list of UI entity descriptions (UIED list 116), which serves as a reverse-chronological blueprint in the target modality for the website's original build process.

FIG. 2A shows a flow chart of the overall iterative deconstruction process 200 managed by the deconstructor module 106A. The process begins with a copy of the original website 208, which becomes the initial Current Website (CWS) 202. CWS 202 is the active subject of the sequence of deconstruction cycles.

In multiple cycles of the process, the CWS 202 is analyzed by a last UI entity identifier module 204. Module 204, powered by the AI/ML engine (104), is configured to identify the most probable UI entity that was added last to the CWS 202. Once the final entity is identified and its characteristics are recorded in the UIED list (116), a last UI entity remover module 206 removes the identified entity from CWS 202.

The resulting, now-smaller website becomes the new CWS for the next iteration of the loop. The process of identifying, recording, and removing repeats until the CWS 202 is fully deconstructed, for example, into an empty state or down to its base template.

FIG. 2B illustrates the internal workflow 210 of the last UI entity identifier module 204. This demonstrates a hierarchical approach to the analysis performed by the AI/ML engine in the iteration. First, the system reads the current state of the CWS (operation 220). The AI/ML engine then performs a macro-level analysis to find the last page added to the website (operation 222), thereby narrowing the search space. Following this, the engine performs a more granular analysis within the identified page to find the last element (UI entity) added to it (operation 224). The output of the sub-process 224 is the metadata and data of that specific last-added element, which is then recorded in the UIED list.

In this context, the term “last-added” refers to the UI entity that the AI/ML engine infers, based on the captured website representation and any available supporting information, to have been most recently introduced into that representation. For highly dynamic or client-side rendered sites, the term “last-added” indicates a probabilistic inference about the underlying build sequence rather than a guarantee that the element was literally added last in the original source-control or editing history.

First, the system reads the current state of the CWS (operation 220). The AI/ML engine then performs a macro-level analysis to find the last page added to the website (operation 222). The initial step narrows the search space. Following this, the engine performs a more granular analysis within that identified page to find the last element (UI entity) added to it (operation 224). The output of the sub-process is the metadata and data of that specific last-added element, which is then recorded in the UIED list.

FIGS. 3A and 3B provide concrete examples of the intelligent, logic-based analysis performed by the AI/ML engine during the identification sub-process.

FIG. 3A shows an example 300 of the logic used to find the last page (operation 222). As shown, the AI/ML engine is configured to consider not just the code structure but also the content and functionality of the pages. In this simplified example, the AI/ML engine treats pages serving introductory or informational purposes, such as an “About Page” and a “Main Page”, as foundational, and treats a “Contact Page” as a page that is often added towards the end of development to provide a point of interaction for users. Based on these heuristics and known patterns, the AI identifies the “Contact Page” as the most probable last-added page and records a corresponding confidence score. This example is illustrative and does not imply that all websites follow this pattern; in practice, the AI/ML engine uses statistically learned patterns and supporting information to make probabilistic inferences about build order.

FIG. 3B shows an example 310 of the logic used to find the last element within a page (operation 224). Having identified the “Contact Page,” the engine analyzes its contents. In this scenario, the AI/ML engine may infer that a button allowing a user to navigate back to the “Main Page” was likely the last element added. The reasoning is based on heuristic UI/UX design patterns: navigation elements that connect different sections of a website are often implemented or adjusted toward the end of page development to ensure a coherent and complete user experience. However, the actual order in which elements are implemented can vary widely between projects. Accordingly, in some embodiments, this inference is treated as probabilistic, and the system can expose both the inferred last-added element and alternative candidates, along with their respective confidence scores, to downstream components such as the construction feedback module 106B.

To further illustrate the technical nature of the reverse-chronological blueprint, reference is made to a non-limiting example of a data structure for a single user interface (UI) entity description as may be recorded in the UIED list (116).

In some embodiments, the AI/ML engine 104, upon identifying a last-added UI entity, generates a structured data object describing that user interface (UI) entity. The description contains specific metadata and data attributes essential for the construction phase. The resultant description may be recorded in the UIED list 116.

An exemplary data structure may comprise the following fields: a unique entity_id for unambiguous referencing; a dom path specifying the entity's precise location within the Document Object Model tree of the source website 110; an optional creation_timestamp, where available, providing chronological data that the AI/ML engine 104 can use to verify or refine its inferred sequence; and a dependencies array listing the specific resources, such as Cascading Style Sheets (CSS) selectors or JavaScript (JS) event handlers, that the entity relies on for its appearance and functionality. The data structure may further comprise a position_data object, defining the entity's geometric properties such as x/y coordinates, width, height, and z-index, which are critical for preserving the visual layout. A content_hash, for example a SHA-256 hash of the entity's content, may be included to ensure data integrity and detect modifications. The structure may include a confidence_score, which is a numerical value (e.g., 0.0 to 1.0) output by the AI/ML engine 104 indicating its level of certainty that the entity was indeed the last one added in its local context. A list of alternative_candidates may be stored, documenting other UI entities that the AI/ML engine 104 considered, which can be utilized by the construction feedback module 106B to provide a user with alternative choices during the construction phase. One or more of these fields may be omitted, left unset, or populated with approximate values when the corresponding information is unavailable or only indirectly inferable for a given source website, such as in public-web scenarios where per-entity timestamps are not reliably exposed.

This granular, machine-readable blueprint ensures that every aspect of a UI entity—its position, appearance, behavior, and content—is captured so that reconstruction in the target modality preserves the original website's structure and UI/UX logic.

Through the structured deconstruction process, the deconstructor module 106A creates a highly detailed and logically ordered blueprint that captures the original design intent, and enabling an accurate and robust reconstruction in the target modality.

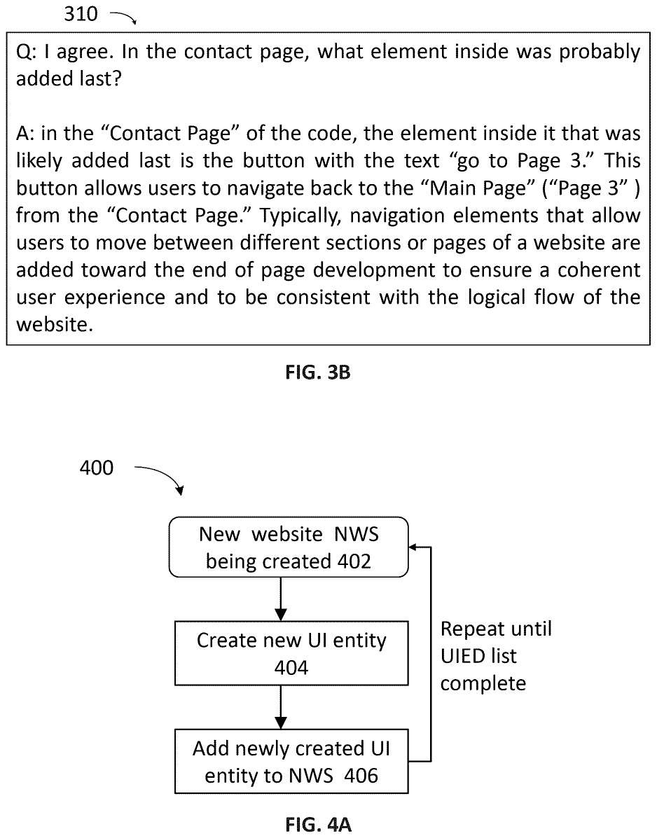

Reference is now made to FIG. 4A, which is a flow chart illustrating the construction process 400 managed by the constructor module 106C in accordance with some embodiments of the present disclosure. The process is responsible for rebuilding the website in the target modality using the blueprint generated during the deconstruction phase.

Process 400 begins with the creation of a new, blank website (NWS) 402 in the target modality. The constructor module 106C then accesses the chronologically ordered UIED list (116). Constructor module 106C processes the UIED list sequentially, from the first-added entity to the last.

The constructor module 106C, guided by the AI/ML engine (104), proceeds to create a new UI entity (operation 404). The operation involves interpreting the description of a source UI entity from the blueprint and generating a corresponding, functionally equivalent new entity that is native to the target modality. Finally, the newly created UI entity is added to the NWS (operation 406), progressively assembling the new website. The cycle of creating and adding entities continues until the entire blueprint has been processed, resulting in a reconstructed website that preserves the original website's structure and UI/UX logic.

The operation of the constructor module 106C embodies an intelligent translation of functional intent rather than a direct replication of source code or infrastructure. Even when the constructor module 106C successfully identifies a matching entity, the implementation between the source modality and the target modality may be different.

Functional purpose and native components. As used herein, a UI entity's “functional purpose” (or “functional intent”) refers to the role the UI entity plays in the user experience and in the website's interaction logic. Non limiting examples include navigation (e.g., menu, breadcrumb, back button), content presentation (e.g., hero section, carousel), data input (e.g., form field, file upload), conversion (e.g., call to action, checkout step), search/filtering, authentication/account management, embedded/interactive media, and external integrations (e.g., map, booking, payments). The AI/ML engine may infer functional purpose based on one or more of the entity's structure and attributes (including DOM structure), semantic signals (e.g., labels, ARIA attributes, surrounding text), styling patterns, event handlers, linked resources, layout context, and/or supporting information. A “native component” of the target modality is a component, widget, implementation pattern, or template element provided by (or idiomatic to) the target modality that can be selected and instantiated to achieve the same functional purpose, even when the underlying code, infrastructure, and data handling differ between modalities.

The AI/ML engine (104) is configured to deconstruct the source website based on the functional purpose of its UI entities and generates a build plan in the context of the target modality. The constructor module 106C then uses this build plan to intelligently select the correct, native components and implementation patterns in the target modality to achieve the same functional result.

The term ‘modality’ is used to denote a complete and distinct technological ecosystem used to create, operate, and render a website, including the comprehensive technological and architectural framework of a website.

Differences between modalities may reflect differences in one or more of the following aspects: Infrastructure and Website Technology; Backend Solutions and Data Interaction; Implementation of User Interface (UI) Entities; and Templates and Reusability.

For example, a source modality might rely on a traditional LAMP (Linux, Apache, MySQL, PHP) server where pages are dynamically generated for the request. A target modality may use a distributed, cloud-native infrastructure.

In another example, a backend solutions and data interaction of a traditional monolithic Content Management System (CMS) like WordPress processes form submissions with a server-side PHP script that interacts directly with a relational MySQL database. In contrast, a modern headless or Jamstack architecture would use a client-side component to make an asynchronous API call to a serverless function, which then forwards data to a non-relational database.

In yet another example, the implementation of UI Entities may be different—in an older modality, a UI entity like an image carousel might be built with imperative logic, directly manipulating the Document Object Model (DOM). In a modern, component-based modality, the same carousel would be a self-contained, declarative component that manages its own state and re-renders automatically when the state changes.

The concept of a “template” may also differ across modalities—a template in a source modality might be a set of server-side include files, and in a target modality, a template is more likely a collection of reusable client-side UI components.

While a specific UI entity presented to the end-user may appear identical, the underlying code, infrastructure, and data handling are completely different and native to the target modality.

In some embodiments of the present disclosure, the constructor module 106C and the AI/ML engine 104 are configured to identify functionally equivalent components and to recognize situations where a direct automated translation is not feasible or optimal. The necessity for intelligent adaptation and the potential for incompatibility leads directly to the mechanisms for handling exceptions, which are managed through the construction feedback module (106B).

Reference is now made to FIG. 4B, which is a block diagram illustration detailing the options 410 for creating a new User Interface (UI) entity (operation 404 of FIG. 4A) during the construction process. This process is managed by the constructor module 106C and, in some embodiments, may involve the construction feedback module 106B to handle complexities arising from migrating between different modalities.

The AI/ML engine (104) is configured to determine if a UI entity from the source modality can be directly replicated in the target modality. When a direct, automated replication that preserves the original functionality is not feasible, the system may invoke the construction feedback module (106B) to present a user with a set of structured choices, thereby partitioning the reconstruction task. This allows the system to automate what is computationally feasible while generating specific, actionable instructions for parts that require manual intervention. The options for creating the new UI entity (404) may include:

The system may add a matching entity (operation 420). In some embodiments, operation 420 is the default or ideal scenario where the AI/ML engine (104) identifies a functionally equivalent component in the target modality's library or technological capabilities. The constructor module (106C) then generates and adds this new UI entity, which may be a direct replica or an intelligently modernized equivalent that serves the same functional purpose as the source entity.

In situations where direct replication is not possible due to incompatible code or unavailable functionality, the system may add a placeholder entity (operation 422). In this case, the constructor module (106C) generates a placeholder, such as a <div> element with a descriptive note in the code and inserts it into the new website 114. The added placeholder reserves the structural space for the entity and serves as a clear marker for a human developer (or a code development automated entity), indicating that a new coding or integration is required at that specific location.

As an alternative or in addition to a placeholder, the system may add a note (operation 424). The ‘add note’ option, which may be presented through the construction feedback module 106B, involves generating a task or instruction for a manual process. This task can be exported to an external task-management system. For example, if a source entity's functionality requires a custom API that does not exist in the target modality, the system could generate a task that reads: “Implement interactive map functionality for the ‘Locations’ page.” This creates a discrete, actionable instruction for a developer, handling complexities that fall outside the scope of automated reconstruction.

The resultant workflow 410, facilitated by the operational options 420, 422 and 424 shown in FIG. 4B, enables complex website migration scenarios to be handled by allocating tasks between automated reconstruction and human review, thereby optimizing the allocation of computational and human resources.

Reference is now made to FIG. 5, which is a schematic illustration of an overall system architecture 50, constructed and operative in accordance with some embodiments of the present disclosure. FIG. 5 shows the high-level interaction between a source modality 502 and a target modality 504, facilitated by a Website Building System (WBS) 500.

The WBS 500 comprises a deconstructor and constructor module 506 and an Artificial Intelligence/Machine Learning (AI/ML) engine 508. The system 500 is configured to receive input from the source modality 502, which includes an original website 510 to be reconstructed and, in some cases, website templates 512 that may have been used to create the original website 510.

The AI/ML engine 508 is configured to analyze the original website 510, potentially leveraging support information 522 to understand its structure and build logic. A filter module 524 may be included, which can function as a “guardrail” to sanitize a copy of the original website 510 before deconstruction, for instance, to ensure that the legal or intellectual property rights of a third-party website owner are not infringed upon when creating a new website “inspired by” it.

The deconstructor and constructor module 506, guided by the AI/ML engine 508, performs the deconstruction and construction processes to generate a new website 514 within the target modality 504. The target modality 504 may have its own set of distinct website templates 516 and native components.

The WBS 500 comprises a deconstructor and constructor module 506 and an Artificial Intelligence/Machine Learning AI/ML engine 508. System 500 is configured to analyze an original website 510 from the source modality 502 to generate a new website 514 in the target modality 504. To that end, as illustrated by the ‘Training’ arrow pointing from the target modality 504, the AI/ML engine 508 is trained on the data, components, and website templates (516) of the target modality. This training is what enables the system to function as an intelligent translator. It allows the AI/ML engine 508 to support and deconstructions as well as construction operations. AI/ML engine 508 learns the rules, available native components, implementation patterns, and architectural constraints of the destination environment.

In some embodiments, as indicated by the optional ‘Training’ arrow pointing from the source modality 502, the AI/ML engine 508 may also be trained on data from the source modality. This optional training may enhance the performance of the deconstruction phase. By learning the specific conventions, component dependencies, and common structures of the source modality 502, including its website templates 512, the AI/ML engine 508 can make more accurate and efficient inferences about the original build logic of the website 510. While the system can deconstruct a source website using general web-development knowledge, this optional training on the source modality can improve the accuracy and speed of generating the reverse-chronological blueprint (UIED list 116), particularly for complex or unconventional website structures.

In the context of the present disclosure, website templates (512, 516) are pre-designed foundational structures for a website. They provide a starting point with a pre-defined layout, style, and set of components. The AI/ML engine 104 (and AI/ML engine 508 in the architecture of FIG. 5) is configured to recognize and leverage these templates to create a reconstruction workflow that reduces redundant deconstruction and reconstruction operations.

In some embodiments, the deconstruction process is optimized by leveraging website templates. The AI/ML engine 104 is configured to analyze the source website 110, 510 to determine whether it was created from a known base template 512.

If the AI/ML engine 104 determines, with sufficient confidence, that the source website was built on a template, the goal of the deconstruction phase changes. Instead of deconstructing the website down to a completely blank state, the deconstructor module 106A is configured to perform a more targeted analysis. The objective becomes to identify the base template and then to generate a list of the customizations that were made to it. These customizations represent the specific UI entities, content, and style changes that the original designer applied to the template to create the final website.

This method results, when a reliable template match exists, in a reverse-chronological blueprint (UIED list 116) that may be more concise. The blueprint contains a reference to the base template and the ordered list of customizations, rather than a list of every single UI entity on the site. Leveraging templates can make the deconstruction more efficient by avoiding redundant computational work of reverse-engineering foundational elements that are already defined within the template; when a template match is not reliable, the system may fall back to a full deconstruction of the website.

Templates may also be used in the construction process. The template-based blueprint generated during deconstruction enables a construction phase that can be faster than reconstructing every UI entity individually. When a suitable template in the target modality 504 has been identified, the construction process may begin by instantiating the identified base template within the target modality 504. The AI/ML engine 104, having been trained on the target modality's templates 516, may select the original template or identify a newer, more suitable, or functionally equivalent version available in the target modality. Once the template is instantiated, the constructor module 106C processes the ordered list of customizations from the blueprint and applies these customizations sequentially to the new template instance, thereby rebuilding the website. In scenarios where the template match is accurate, the speed and efficiency of the computer system may be improved, as it leverages pre-built, defined structures and primarily generates and adds the specific UI entities that constitute the customizations. This may significantly reduce the overall processing time, memory usage, and computational load required to generate the new website 114, 514. In other scenarios, where no reliable template match is found, the system may instead employ the more general deconstruction and reconstruction process described above.

In some embodiments, the AI/ML engine 508 may also leverage support information 522 to further augment its analysis. As shown in FIG. 5, the AI/ML engine 508 may use a rich set of support information 522 to enhance the reconstruction plan. The supporting information may provide deeper contextual data that is not available from analyzing the final rendered website alone. In some embodiments, supporting information may include:

Editing History (EH): This refers to the detailed, chronological log of actions taken by a designer to build the original website 510. Instead of merely inferring the build order, the system can analyze the actual editing history. Because a designer's process is often non-linear (e.g., adding, deleting, and re-adding an element), the system may use the Editing History EH as an additional source to refine and, where appropriate, simplify the deconstruction and construction plan, while preserving the effective behavior of the resulting site.

Additional Data Sources: This is a broad category of contextual information. It may include published version history of the website, which shows its evolution over time; user documentation, which explains the purpose and functionality of different elements, providing semantic context; and the source code itself (e.g., HTML, CSS, JavaScript), which an LLM can analyze to understand hidden dependencies and the logic of interactive features.

The additional data sources may be, for example, (a) published version history (i.e., website versions that were published.) (b) user documentation for the CWS. (c) snapshots of the CWS (e.g., as found on archive.org). (d) code included in the CWS; (e) component dependencies; (f) styling patterns—which AI/ML engine 104 can analyze.

The supporting information provides a multi-faceted view of the website. For example, version history and snapshots show the website's evolution over time, which can help the AI/ML engine 104 to better understand the order in which major sections were likely developed. User Documentation explains the purpose and functionality of different elements, giving AI/ML 104 semantic context that is not available from the visual layout alone. AI/ML 104 may conduct source website code analysis (HTML, CSS, JavaScript) to understand hidden dependencies, relationships between elements, and the logic of interactive features. Timestamps and Dates: This metadata, which may be part of the additional data sources, can provide direct chronological clues that help the AI/ML engine 508 verify the sequence of element creation and modification.

In some embodiments, the WBS 500 may include an optional filter module 524, as indicated by its dashed outline in FIG. 5. This module functions as a “guardrail” and is particularly useful in scenarios where the original website 510 is not owned by the user performing the reconstruction, such as when creating a new website “inspired by” or “in the style of” an existing third-party site.

The filter module 524 is configured to process or “sanitize” a copy of the original website 510 before it is analyzed by the deconstructor module (506) and the AI/ML engine (508). This filtering process is designed to identify and remove or modify elements that could infringe on the legal or intellectual property rights of the original website's owner or otherwise breach third party rights. For example, the filter module 524 may be configured to remove specific copyrighted content such as text blocks and images, strip out registered trademarks or logos, and neutralize proprietary code snippets.

The output of the filter module 524 is a sanitized representation of the source website. By operating on this filtered version, the system can deconstruct the structural and functional essence of the website while ensuring that the resulting new website 514 does not contain infringing material. This allows the system to be used for legitimate purposes like competitive analysis or creating stylistically similar sites without directly copying protected assets.

With reference to FIG. 5, according to a broad aspect of the present disclosure there is provided a system 500 for reconstructing an original website 510 of a source modality 502 into a new website 514 of a target modality 504, the original website 510 comprising a plurality of user interface UI entities, the system 500 comprising: an AI/ML engine 508 trained on a plurality of websites and website templates 516 of the target modality 504, the AI engine 508 configured to (i) analyze a representation of the original website 510 to determine a functional purpose of the plurality of UI entities; and (ii) select, based on said analysis and said training, a native component of the target modality 504 that corresponds to the functional purpose of the UI entity; and a constructor module 506 configured to generate the new website 514 using the selected native components. There is further provided a computer-implemented method for reconstructing an original website 510 of a source modality 502 into a new website 514 of a target modality 504, the original website 510 comprising a plurality of user interface UI entities, the method comprising (i) training an AI/ML engine 508 on a plurality of websites and website templates 516 of the target modality 504; (ii) analyzing, by the trained AI engine 508, a representation of the original website 510 to determine a functional purpose of the plurality of UI entities; (iii) selecting, by the trained AI engine 508 and based on said analysis and said training, a native component of the target modality 504 that corresponds to the functional purpose of the UI entity; and (iv) generating, by a constructor module 506, the new website 514 using the selected native components.

The AI/ML engine (104, 508) as described herein is a computer-implemented computational entity configured to process input data and execute goal-directed actions. In some embodiments of the present disclosure, the AI/ML engine (104, 508) may be implemented using one or more machine learning models, which are complex models and algorithms that learn from data to make predictions or decisions. As examples, the underlying models may be learning models (supervised or unsupervised) and may include classification algorithms such as decision trees, sequence to sequence models such as Recurrent Neural Networks (RNNs), Long Short-Term Memory (LSTM) models, or transformer-based models, clustering algorithms such as K-means clustering, or generative models such as Generative Adversarial Networks (GANs) or diffusion-based models. In some embodiments, the AI/ML engine (104, 508) may be or may comprise a large language model (LLM) configured to analyze source code such as HTML, CSS, and JavaScript to understand dependencies and the logic of interactive features. The AI/ML engine (104, 508) is fitted or trained on a training dataset, such as the websites and website templates (516) of the target modality (504) and, in some embodiments, data from the source modality (502), to enable it to perform its analysis and selection functions.

In some embodiments, the AI/ML engine (104, 508) is implemented as one or more machine-learning models trained to predict, for a given representation of a website state, a UI entity that was added at a particular step in a build sequence. Training data may be constructed from historical website projects stored in the CuMS 108 and from source-modality websites 510. For each project, an editing history or version history is processed to generate an ordered sequence of website states and associated UI entity additions.

During training, each input sample may comprise features derived from the current website state, including one or more of: a representation of the DOM structure, types of UI entities present, layout metrics, and component dependencies, and may optionally incorporate supporting information 522 such as timestamps, labeling information from user documentation, and version identifiers. The target label for each sample may identify the UI entity that was actually added at that step. Model parameters are adjusted to minimize a loss function that penalizes incorrect predictions of the last-added or next UI entity, for example a cross-entropy loss over candidate UI entities. Once trained, the AI/ML engine (104, 508) may be deployed to infer, given a snapshot of a website state, a most probable last-added UI entity during deconstruction and to suggest one or more functionally equivalent components for use by the constructor module during construction.

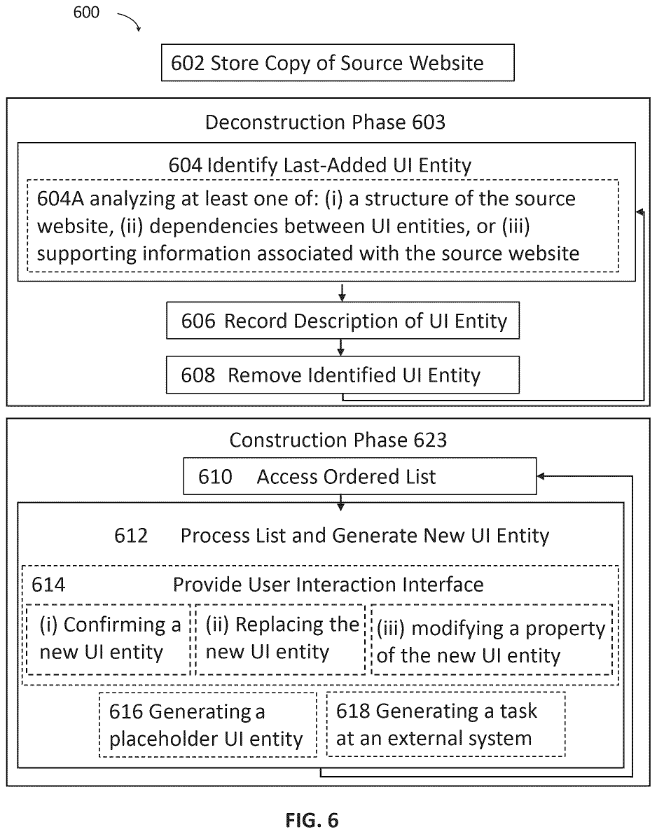

Reference is now made to FIG. 6, which is a flow chart illustration of a computer-implemented method 600 for reconstructing a source website, constructed and operative in accordance with some embodiments of the present disclosure. The method 600 begins with operation 602, Store Copy of Source Website, wherein a copy of the source website is stored e.g., by the Customer Management System (CuMS) 108 of FIG. 1A. The method proceeds to a deconstruction phase 603, which comprises an iterative loop of several operations. The loop begins with operation 604, Iteratively Identify Last-Added UI Entity, wherein a last-added User Interface (UI) entity is identified from the copy of the source website e.g., by the deconstructor and constructor module 106 of FIG. 1A, using e.g., the AI/ML engine 104 of FIG. 1A. This identification may optionally include operation 604A of analyzing at least one of: (i) a structure of the source website, (ii) dependencies between UI entities, or (iii) supporting information associated with the source website, e.g., by the AI/ML engine 104 of FIG. 1A. Following the identification, the method proceeds to an operation 606, Record Description of UI Entity, wherein a description for the identified entity is recorded e.g., by the deconstructor and constructor module 106 of FIG. 1A into an ordered list, stored e.g., by CuMS 108 of FIG. 1A. Subsequently, in operation 608, Remove Identified UI Entity, the identified entity is removed from the copy of the source website e.g., by the deconstructor and constructor module 106 of FIG. 1A. These deconstruction operations are repeated until the copy is deconstructed. The method 600 then proceeds to a construction phase 623, beginning with an operation 610, Access Ordered List, wherein the ordered list of UI entity descriptions is accessed e.g., by the deconstructor and constructor module 106 of FIG. 1A. In operation 612, Process List and Generate New UI Entity, the ordered list is processed in a forward-chronological order to generate and add a corresponding new UI entity to the new website e.g., by the deconstructor and constructor module 106 of FIG. 1A. In some embodiments, the method 600 may further comprise an optional operation 614, Provide User Interaction Interface, wherein a user interface is provided by the system, enabling a user to interact with the construction process by (i) confirming a new UI entity, (i) replacing the new UI entity, or (iii) modifying a property of the new UI entity. Furthermore, the method may include an optional operation 616 of generating a placeholder UI entity or optional operation 618 of generating a task at an external system, where it is determined e.g., by the deconstructor and constructor module 106 of FIG. 1A that a UI entity cannot be directly replicated. The construction operations are repeated for a sequence of UI entity descriptions until the new website is complete.

Various website copying or cloning techniques may be used to obtain a copy of a website; the present disclosure is compatible with such techniques and is not limited to any particular cloning implementation.

In some embodiments, the method and system of the present disclosure can be used in conjunction with other techniques (as described above), so that different parts of the website are cloned or reconstructed in different ways.

For ease of explanation, the method and system of the present disclosure were illustrated in the context of the reconstruction of a single site. However, it may also be used in conjunction with the reconstruction of a part of a site, or a complex component/module/plug-in of a site. Further, the method and system of the present disclosure may be used in conjunction with the reconstruction of a group of sites.

In some embodiments of the present disclosure, the AI-driven deconstruction operates on an inferential basis, identifying the “most probable last-added UI entity” rather than relying on a deterministically known edit history. This iterative identification and removal process proceeds in a “reverse-chronological deconstruction sequence” until the source website copy is reduced to an explicit base state, which may be an empty state or a recognized base template. The resulting blueprint of UI entity descriptions is then normalized for a “forward-chronological” reconstruction, enabling a logical and sequential rebuilding of the website from its foundational elements to its final state.

Thus, according to some embodiments, there is provided a system for reconstructing a source website of a source modality into a new website of a target modality, the source website comprising a plurality of user interface (UI) entities, the system comprising: a Customer Management System, CuMS, configured to store a copy of the source website; and a deconstructor and constructor module in communication with an artificial intelligence/machine learning (AI/ML) engine, the deconstructor and constructor module being configured to: iteratively, while the copy of the source website has not yet been deconstructed to a base state comprising at least one of an empty state of the copy and a base template of the source website, cause the AI/ML engine to analyze a current state of the copy of the source website and, based on the analysis: (i) identify a UI entity of the current state as a most probable last-added UI entity; (ii) record a description of the identified UI entity in an ordered list of UI entity descriptions; and (iii) remove the identified UI entity from the copy of the source website; thereby generating the ordered list of UI entity descriptions as a reverse-chronological blueprint of the copy of the source website, wherein the ordered list of UI entity descriptions is ordered in a forward-chronological order from a first-added UI entity description to a last-added UI entity description; and subsequently, iteratively access the ordered list of UI entity descriptions and process the ordered list in the forward-chronological order to generate and add, for each UI entity description, a corresponding new UI entity to the new website in the target modality.

According to an aspect of the present disclosure, there is provided a computer-implemented method for reconstructing a source website of a source modality into a new website of a target modality, the source website comprising a plurality of user interface (UI) entities, the method comprising: storing, in a Customer Management System, CUMS, a copy of the source website; iteratively, while the copy of the source website has not yet been deconstructed to a base state comprising at least one of an empty state of the copy and a base template of the source website: (i) analyzing, by a deconstructor artificial intelligence/machine learning (AI/ML) engine, a current state of the copy of the source website to identify a UI entity of the current state as a most probable last-added UI entity; (ii) recording a description of the identified UI entity in an ordered list of UI entity descriptions; and (iii) removing the identified UI entity from the copy of the source website; thereby creating the ordered list of UI entity descriptions as a reverse-chronological blueprint of the copy of the source website, wherein the ordered list of UI entity descriptions is ordered in a forward-chronological order from a first-added UI entity description to a last-added UI entity description; and by a constructor module, accessing the ordered list of UI entity descriptions and processing the ordered list in the forward-chronological order to generate and add, for each UI entity description, a corresponding new UI entity to the new website in the target modality.

According to another broad aspect of the disclosure, and with reference to the architecture shown in FIG. 5, the system may operate as a “functional-intent translator.” In the functional-intent translation embodiment, website reconstruction does not depend on a sequential deconstruction process. In the functional-intent translation embodiment, the artificial intelligence/machine learning (AI/ML) engine is specifically trained on a plurality of websites and website templates of the target modality. By learning the rules, patterns, and available components of the destination environment, the engine is configured to analyze a representation of the original website and determine the functional purpose of its constituent user interface (UI) entities. Based on the inferred purpose, the AI/ML engine intelligently selects a corresponding native component from the target modality that is designed to fulfill that same function. The new website is then generated using these selected native components, resulting in a functionally equivalent but natively built reconstruction.

Thus, according to another aspect of the present disclosure, there is provided a system for reconstructing an original website of a source modality into a new website of a target modality, the original website comprising a plurality of user interface (UI) entities, the system comprising: an artificial intelligence/machine learning (AI/ML) engine trained on a plurality of websites and website templates of the target modality, the AI/ML engine being configured to: (i) analyze a representation of the original website to determine a functional purpose of respective UI entities of the plurality of UI entities; and (ii) select, based on the analysis and the training, for at least one of the UI entities, a native component of the target modality that corresponds to the functional purpose of that UI entity; and a constructor module configured to generate the new website using the selected native components.

According to yet another aspect of the present disclosure there is provided a computer-implemented method for reconstructing an original website of a source modality into a new website of a target modality, the original website comprising a plurality of user interface (UI) entities, the method comprising: training an artificial intelligence/machine learning (AI/ML) engine on a plurality of websites and website templates of the target modality; analyzing, by the trained AI/ML engine, a representation of the original website to determine a functional purpose of respective UI entities of the plurality of UI entities; selecting, by the trained AI/ML engine and based on the analysis and the training, for at least one of the UI entities, a native component of the target modality that corresponds to the functional purpose of that UI entity; and generating, by a constructor module, the new website using the selected native components.

According to an aspect of the present disclosure, there is provided a system for reconstructing an original website of a source modality into a new website of a target modality, the original website comprising a plurality of user interface (UI) entities, the system comprising: an artificial intelligence/machine learning (AI/ML) engine trained on a plurality of websites and website templates of the target modality, the AI/ML engine being configured to: (i) analyze a representation of the original website to determine a functional purpose of respective UI entities of the plurality of UI entities; and (ii) select, based on said analysis and said training, for at least one of the UI entities, a native component of the target modality that corresponds to the functional purpose of that UI entity; and a constructor module configured to generate the new website using the selected native components. In some embodiments, the source modality may be different from the target modality. In some embodiments, the AI/ML engine may be further trained on data from the source modality. In some embodiments, the representation of the original website may comprise at least one of: document Object Model, DOM, information; a hierarchical listing of UI entities; and supporting information associated with the original website including at least one of editing history, version history, user documentation, and source code. In some embodiments, the system may further comprise a filter module configured to process a copy of the original website to remove or modify one or more elements prior to analysis by the AI/ML engine. In some embodiments, the filter module may be configured to remove or modify at least one of: text blocks, images, trademarks, logos, and proprietary code snippets subject to third-party rights. In some embodiments, the system may further comprise a construction feedback module configured to provide a user interface enabling a user to interact with the constructor module, the user interaction including at least one of: confirming a generated new UI entity; replacing the generated new UI entity with an alternative new UI entity suggested by the AI/ML engine; and modifying a property of the generated new UI entity. In some embodiments, in response to determining that a UI entity from the original website cannot be directly replicated using a native component of the target modality, the constructor module may be configured to perform at least one of: (a) generating a placeholder UI entity in the new website indicating that a manual integration is required; and (b) generating a task for an external task-management system, the task comprising an instruction for a manual process.

In some embodiments, the system may further comprise a Customer Management System (CuMS) configured to store a copy of the original website; and a deconstructor module configured to generate said representation of the original website as an ordered list of UI entity descriptions by iteratively deconstructing the copy of the original website. The deconstructor module may be configured to, while the copy of the original website has not yet been deconstructed to a base state comprising at least one of an empty state and a base template of the original website, iteratively: (i) analyze a current state of the copy, using the AI/ML engine, to identify a UI entity as a most probable last-added UI entity; (ii) record a description of the identified UI entity in said ordered list of UI entity descriptions; and (iii) remove the identified UI entity from the copy of the original website; thereby generating the ordered list of UI entity descriptions as a reverse-chronological blueprint of the original website, wherein the ordered list of UI entity descriptions is ordered in a forward-chronological order from a first-added UI entity description to a last-added UI entity description. The constructor module may be configured to process the ordered list of UI entity descriptions in the forward-chronological order to generate and add, for each UI entity description, a corresponding new UI entity to the new website in the target modality. The UI entity description may comprise at least one of: a unique entity identifier; a DOM path; dependency information identifying resources used by the UI entity; position data including coordinates, dimensions and stacking order; a content hash; a confidence score indicating a level of certainty that the UI entity was the last-added UI entity in a local context; and a list of alternative candidate UI entities. The AI/ML engine may be further configured to analyze supporting information associated with the original website, the supporting information comprising at least one of: editing history, published version history, user documentation, snapshots of the website, and source code, to assist the deconstructor module in identifying the most probable last-added UI entity at each iteration. Upon the AI/ML engine determining that the original website was created from a website template, the deconstructor module may be configured to: (i) identify a base template; and (ii) generate said ordered list of UI entity descriptions as a list of customizations relative to the base template; and the constructor module may be configured to instantiate a template of the target modality corresponding to the base template and to apply the list of customizations to the instantiated template to generate at least part of the new website.

According to an aspect of the present disclosure, there is provided a computer-implemented method for reconstructing an original website of a source modality into a new website of a target modality, the original website comprising a plurality of user interface (UI) entities, the method comprising: training an artificial intelligence/machine learning (AI/ML) engine on a plurality of websites and website templates of the target modality; analyzing, by the trained AI/ML engine, a representation of the original website to determine a functional purpose of respective UI entities of the plurality of UI entities; selecting, by the trained AI/ML engine and based on said analysis and said training, for at least one of the UI entities, a native component of the target modality that corresponds to the functional purpose of that UI entity; and generating, by a constructor module, the new website using the selected native components. The source modality may be different from the target modality. The method may further comprise training the AI/ML engine on data from the source modality. The representation of the original website may comprise at least one of: Document Object Model, DOM, information; a hierarchical listing of UI entities; and supporting information associated with the original website including at least one of editing history, version history, user documentation, and source code. The method may further comprise, prior to analyzing the representation, processing a copy of the original website by a filter module to remove or modify one or more elements of the copy. The processing the copy of the original website may comprise removing or modifying at least one of: text blocks, images, trademarks, logos, and proprietary code snippets subject to third-party rights. The method may further comprise providing, by a construction feedback module, a user interface enabling a user to interact with the constructor module, the user interaction including at least one of: confirming a generated new UI entity, replacing the generated new UI entity with an alternative new UI entity suggested by the AI/ML engine, and modifying a property of the generated new UI entity. The method may further comprise, in response to determining that a UI entity from the original website cannot be directly replicated in the target modality using a native component, performing at least one of: (a) generating a placeholder UI entity in the new website indicating that a manual integration is required; and (b) generating a task for an external task-management system, the task comprising an instruction for a manual process.

The method may further comprise storing, in a Customer Management System, CuMS, a copy of the original website; and by a deconstructor module, generating said representation of the original website as an ordered list of UI entity descriptions by iteratively deconstructing the copy of the original website. The generating the ordered list of UI entity descriptions may comprise, while the copy of the original website has not yet been deconstructed to a base state comprising at least one of an empty state and a base template of the original website, iteratively: (i) analyzing, by the AI/ML engine, a current state of the copy to identify a UI entity as a most probable last-added UI entity; (ii) recording a description of the identified UI entity in said ordered list of UI entity descriptions; and (iii) removing the identified UI entity from the copy of the original website; thereby generating the ordered list of UI entity descriptions as a reverse-chronological blueprint of the original website, wherein the ordered list of UI entity descriptions is ordered in a forward-chronological order from a first-added UI entity description to a last-added UI entity description. The generating the new website using the selected native components may comprise processing the ordered list of UI entity descriptions in the forward-chronological order to generate and add, for each UI entity description, a corresponding new UI entity to the new website in the target modality. The UI entity description may comprise at least one of: a unique entity identifier; a DOM path; dependency information identifying resources used by the UI entity; position data including coordinates, dimensions and stacking order; a content hash; a confidence score indicating a level of certainty that the UI entity was the last-added UI entity in a local context; and a list of alternative candidate UI entities. The method may further comprise analyzing, by the AI/ML engine, supporting information associated with the original website, the supporting information comprising at least one of: editing history, published version history, user documentation, snapshots of the website, and source code, to assist in identifying the most probable last-added UI entity at each iteration. The method may further comprise, upon determining that the original website was created from a website template: (i) identifying a base template; and (ii) generating said ordered list of UI entity descriptions as a list of customizations relative to the base template; and wherein generating the new website using the selected native components comprises instantiating a template of the target modality corresponding to the base template and applying the list of customizations to the instantiated template.

According to another broad aspect of the present disclosure, there is provided a system for reconstructing an original website of a source modality into a new website of a target modality, the original website comprising a plurality of user interface (UI) entities, the system comprising: an artificial intelligence/machine learning (AI/ML) engine trained on a plurality of websites and website templates of the target modality, the AI/ML engine being configured to: (i) analyze a representation of the original website to determine a functional purpose of respective UI entities of the plurality of UI entities; and (ii) select, based on said analysis and said training, for at least one of the UI entities, a native component of the target modality that corresponds to the functional purpose of that UI entity; and a constructor module configured to generate the new website using the selected native components.

According to yet another broad aspect of the present disclosure there is provided a computer-implemented method for reconstructing an original website of a source modality into a new website of a target modality, the original website comprising a plurality of user interface (UI) entities, the method comprising: training an artificial intelligence/machine learning (AI/ML) engine on a plurality of websites and website templates of the target modality; analyzing, by the trained AI/ML engine, a representation of the original website to determine a functional purpose of respective UI entities of the plurality of UI entities; selecting, by the trained AI/ML engine and based on said analysis and said training, for at least one of the UI entities, a native component of the target modality that corresponds to the functional purpose of that UI entity; and generating, by a constructor module, the new website using the selected native components.

The principles of the present disclosure are not limited to the reconstruction of websites but can be generalized to a broader class of digital content reconstruction systems. The core methodology of iterative deconstruction into a reverse-chronological blueprint and subsequent intelligent construction can be applied to other complex, layered digital artifacts.

In an alternative embodiment, the system of an aspect of the present disclosure may be configured for mobile application reconstruction. In this context, the source modality is a mobile application, and its UI entities are native components of the corresponding operating system (e.g., UI View objects in OS or View objects in Android). The deconstructor module (e.g., 106A) would analyze the application's view hierarchy and resource files to generate the UIED list 116. The constructor module (e.g., 106C) could then use this blueprint to reconstruct the application in a different target modality, such as a cross-platform framework, or to migrate it from an older native version to a newer one, preserving the user experience and interaction logic.

In another embodiment, the system may be applied to document template analysis and reconstruction. A complex document, such as a corporate annual report in PDF format or a marketing brochure created in a specific desktop publishing program, can be treated as the source modality. The system would deconstruct the document layer by layer, identifying text blocks, images, tables, headers, and footers as UI entities. The resulting blueprint could then be used by the constructor module to recreate the document's layout and structure in a different file format or software environment, such as converting a static PDF into an editable web-based template.

In a further embodiment, the invention may be applied to software architecture reverse engineering. In this application, the “entities” are software components such as classes, modules, or functions within a legacy codebase. The deconstruction process, guided by an AI/ML engine, would analyze dependencies, call graphs, and data flows to infer the chronological or logical development sequence of the architecture. The generated blueprint provides a structured understanding of how the system was built, which can be invaluable for modernizing, refactoring, or automatically generating technical documentation for the software system.

The system and method according to aspects of the present disclosure also enable advanced competitive analysis and educational applications. By generating a blueprint of a competitor's website, an organization can gain deep technical insights into their development strategies and feature prioritization, beyond what is apparent from merely viewing the final site. For educational purposes, the generated blueprint can serve as a step-by-step tutorial, demonstrating to a student or junior developer the logical sequence used to construct a professional-grade digital product, thereby providing a tool for web development training.

In yet another embodiment, the system and method of the present disclosure may be adapted for game level design analysis. The source modality in this case is a completed game level within a game engine environment. The entities to be deconstructed are game objects, including static meshes, scripted characters, lighting elements, trigger volumes, and environmental assets. The deconstructor module, guided by an AI/ML engine trained on game design principles, analyzes the scene graph, asset dependencies, and scripting chronology to infer the original level creation sequence. For example, the AI/ML engine may determine that foundational terrain and large architectural structures were created before smaller interactive objects or visual-effect placements. The resulting blueprint, or UIED list, provides a step-by-step reconstruction plan. This blueprint can be used by a constructor module to procedurally generate variations of the level, create automated tutorials for level design, or facilitate migration of the level to a different game engine.

A further embodiment extends the inventive concept to Computer-Aided Design (CAD) and 3D model reconstruction. Here, the source modality is a 3D model, which may be a non-parametric mesh file (such as an STL or OBJ file) or a parametric solid model. The “entities” are the geometric features and operations used to create the model, such as sketches, extrusions, cuts, fillets, and chamfers. The AI/ML engine analyzes the final geometry and topology of the object to reverse-engineer the most probable sequence of modeling operations. It may identify that a base extrusion feature was likely created before a subsequent cut feature, and that a fillet was applied as a finishing operation. The deconstruction process generates a blueprint that effectively recreates the model's parametric history or feature tree. This blueprint can be used to convert a static non-parametric solid model into an editable parametric model, optimize a design process by reordering features for stability, or enable the migration of complex designs between incompatible CAD software platforms.

The system and method of the present disclosure may also be configured for database schema evolution analysis. In this embodiment, the source modality is a database schema definition. The relevant entities are database objects such as tables, columns, indexes, and foreign key constraints. The deconstructor module analyzes the structural relationships within the schema to determine the logical and chronological order of their creation. For instance, the AI/ML engine would infer that a table with a foreign key constraint was created after the primary key table it references. By iteratively identifying and removing the “last-added” database object and recording its definition, the system generates a blueprint representing the sequence of historical database migrations. This blueprint can be used to automatically generate optimized migration scripts for deploying the schema to a new environment, document the evolution of a complex database, or assist in modernizing a legacy database structure.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The inventive elements discussed hereinabove may be implemented on a suitable apparatus. The apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the present disclosure as described herein.

While certain features of the present disclosure have been illustrated and described herein, many modifications, substitutions, changes, and equivalents will now occur to those of ordinary skill in the art. It is, therefore, to be understood that the appended claims are intended to cover all such modifications and changes as fall within the scope of the present disclosure.

What is claimed is:

1. A system for reconstructing a source website of a source modality into a new website of a target modality, the source website comprising a plurality of user interface (UI) entities, the system comprising:
a Customer Management System (CuMS) configured to store a copy of the source website;
a deconstructor and constructor module in communication with a deconstructor artificial intelligence/machine learning (AI/ML) Engine and configured to:
iteratively, until the copy of the source website is deconstructed, identify, using said deconstructor artificial intelligence/machine learning (AI/ML) engine, a last-added UI entity from the copy of the source website; record a description for the identified last-added UI entity; remove the identified last-added UI entity from the copy of the source website, thereby creating an ordered list of UI entity descriptions; and
iteratively access the ordered list of UI entity descriptions; and process the ordered list of UI entity descriptions in a forward-chronological order to generate and add a corresponding new UI entity to the new website in the target modality for the UI entity description.

2. The system of claim 1 further comprising a site generation system configured to receive input from the deconstructor and constructor module and is configured to generate the final new website based on the reconstructed target website.

3. The system of claim 1, wherein the target modality is different from the source modality.

4. The system of claim 1, wherein said deconstructor AI/ML engine is trained on target modality websites.

5. The system of claim 3, wherein said deconstructor AI/ML engine is further trained on source modality websites.

6. The system of claim 2 wherein said deconstructor AI/ML engine is configured to iteratively, until the copy of the source website is deconstructed, identify, a last-added UI entity from the copy of the source website; record a description for the identified last-added UI entity; remove the identified last-added UI entity from the copy of the source website, thereby creating an ordered list of UI entity descriptions; and a constructor module configured to interact with one of said deconstructor AI/ML engine or said site generation system to iteratively access the ordered list of UI entity descriptions and process the ordered list of UI entity descriptions.

7. The system of claim 1, wherein said deconstructor AI/ML engine is further configured to identify the last-added UI entity by analyzing at least one of: a structure of the source website, dependencies between UI entities, or supporting information associated with the source website.

8. The system of claim 7, wherein the supporting information is selected from the group consisting of: an editing history of the source website, user documentation, source code, and a website template (512) used to create the source website.

9. The system of claim 8, wherein upon said deconstructor AI/ML engine determining that the source website was created from the website template (512), the deconstructor module is configured to identify a base template and a list of customizations, wherein the ordered list of UI entity descriptions comprises the list of customizations.

10. The system of claim 6, wherein the constructor module is further configured to, in response to determining that a UI entity from the source website cannot be directly replicated in the target modality, perform one of the following:
generate a placeholder UI entity in the new website, the placeholder UI entity indicating a manual integration is required; or
generate a task for an external task-management system, the task comprising an instruction for a manual process.

11. The system of claim 10, wherein the construction feedback module is further configured to present the user with a plurality of alternative new UI entities for a single UI entity description from the ordered list, and to receive a selection of one of the plurality of alternative new UI entities from the user.

12. The system of claim 10, wherein the construction feedback module is further configured to receive from the user one or more parameters to be applied to a new UI entity before the new UI entity is added to the new website.

13. A computer-implemented method for reconstructing a source website of a source modality into a new website of a target modality, the source website comprising a plurality of user interface (UI) entities, the method comprising:
storing, in a Customer Management System (CuMS), a copy of the source website;
by a deconstructor module:
iteratively identifying, using a deconstructor artificial intelligence/machine learning (AI/ML) engine, a last-added UI entity from the copy of the source website;
recording a description for the identified last-added UI entity;
removing the identified last-added UI entity from the copy of the source website; and
repeating the identifying, recording, and removing steps until the copy of the source website is deconstructed, thereby creating an ordered list of UI entity descriptions; and
by a constructor module:
accessing the ordered list of UI entity descriptions; and
processing the ordered list of UI entity descriptions in a forward-chronological order to generate and add a corresponding new UI entity to the new website in the target modality for the UI entity description.

14. The method of claim 13, wherein the target modality is different from the source modality.

15. The method of claim 13, wherein said deconstructor A/ML engine is trained on target modality websites.

16. The method of claim 13, wherein identifying the last-added UI entity further comprises analyzing, by said deconstructor AI/ML engine, at least one of: a structure of the source website, dependencies between UI entities, or supporting information associated with the source website.

17. The method of claim 13, further comprising: providing, by a construction feedback module, a user interface enabling a user to interact with the constructor module, wherein the user interaction comprises at least one of: confirming a new UI entity, replacing the new UI entity, or modifying a property of the new UI entity.

18. The method of claim 13, further comprising: determining, by the constructor module, that a UI entity from the source website cannot be directly replicated in the target modality; and in response, performing one of the following:
generating a placeholder UI entity in the new website; or
generating a task for an external task-management system.

19. A non-transitory computer-readable medium storing instructions that, when executed by one or more processors, cause the one or more processors to perform the method of claim 13.
